(19) United States
(12) Patent Application Publication
(10) Pub. No.: US 2014/0038803 A1
(43) Pub. Date: Feb. 6, 2014

(54) PRODUCTION OF A SIDEWALL-SEGMENT FOR A CARDBOARD CONTAINER

(71) Applicant: Neil Roderick Marshall, Fareham (GB)

(72) Inventor: Neil Roderick Marshall, Fareham (GB)

(73) Assignee: Huhtamäki Oyj, Espoo (FI)

(21) Appl. No.: 13/640,195

(22) PCT Filed: Jan. 6, 2011
(86) PCT No.: PCT/EP2011/000025

§ 371 Date: May 20, 2013

(30) Foreign Application Priority Data
Apr. 9, 2010 (DE) 10 2010 016 390.2
Jul. 6, 2010 (EP) 10006947.5

(51) Int. Cl. B31B 1/00

(52) U.S. Cl. CPC B31B 1/00
USPC 493/52

(57) ABSTRACT

Process for the production of a sidewall-segment (1) of a container (2) with a shaping (3), wherein the shaping (3) is inserted prior to forming the sidewall-segment into a sidewall of a container and extends around the entire circumference of the container (2).

The present invention relates to a process of the production of a sidewall of a container with a shaping. The present invention further relates to a sidewall-segment.

Containers, especially cardboard containers, like for example cups are, in many cases produced from a segment which is formed. Furthermore, the sidewall needs often a shaping. It was therefore the objective of the present invention to provide a process for the production of a sidewall of a container with a shaping.

This objective is attained by a process for the production of a sidewall-segment of a container with a shaping, whereas the shaping is inserted prior to forming the sidewall-segment into a sidewall of a container and whereas the shaping extents around the entire circumference of the container.

The present invention relates to the production of a sidewall-segment of a container. Such a sidewall-segment is preferably cut out of a web and is thus flat.

The sidewall-segment is preferably made from paper, hard paper, cardboard, fiber material, plastic material, renewable and/or biodegradable raw material or other comparable materials. Preferably, the material is plastically deformable, preferably embossable and more preferably also elastically deformable. All parts of the inventive container are made from this material, whereas the individual parts of the container can be made from different materials.

Especially the surfaces of parts of the container which are subjected to a liquid and/or vapour are provided with means, especially a coating, an impregnation, a film or the like, which makes the parts at least temporarily resistant against for example humidity, water, aqueous solutions, oil and/or fat or a combination thereof. Preferably the above mentioned means are also heat sealable.

According to the present invention, this sidewall-segment comprises a shaping, whereas the shaping is inserted into the sidewall-segment prior to forming the sidewall-segment into a sidewall of a container. Thus, the shaping is inserted into the sidewall-segment while the sidewall-segment is still flat. Furthermore, the shaping preferably extends around the entire circumference of the container. Afterwards, the sidewall-segment is formed into the sidewall of a container. This is preferably done by rolling the sidewall-segment for example into a cylindrically or a conically shaped sidewall. Preferably, the rolling is done around a mandrel. This shaping can be directed inwardly and/or outwardly; i.e. towards the content of the container or away from the content of the container. The shaping can alternate between an inward direction and an outward direction. This alternation is preferably harmonic.

Preferably or according to another subject matter of the present invention, the sidewall-segment is transported, preferably rotated, along a horizontal plane while the shaping is inserted. Rather than moving the shaping tool, the sidewall-segment is moved relative to the shaping tool, preferably in a horizontal plane. The tool remains preferably stationary.

Preferably or according to another embodiment of the present invention, the shaping is pressed into the plane sidewall segment. This can be carried out for example by two dies which move relative to each other, whereas the plane sidewall segment is inserted between the dies. Preferably one die comprises a groove, while the other die comprises a corresponding projection. Alternatively or additionally, the shaping is carried out under the support of vacuum and/or pressure.

The insertion of the shaping can be carried out before or after the individual sidewall segments are cut out of a web or when the sidewall segment is already fixed to transportation means, for example a transfer turret and preferably directly before it is formed into a 3D-shape

Preferably, the shaping is made by plastic deformation. In a preferred embodiment, the plastic deformation is carried out under the influence of pressure and/or heat. More preferably, this plastic deformation is an embossment. In another preferred embodiment, the plastic deformation is a folding.

According to another preferred embodiment of the inventive process, the shaping is made by material removal. For example the material can be cut off by a knife or by a laser.

In a preferred embodiment of the present invention, the shaping is compressed after it has been inserted into the sidewall-segment. Consequently, in a more preferred embodiment of the present invention, the sidewall-segment comprises compression-improvement-means, which are preferably located parallel, more preferably in the vicinity and even more preferably in the direct vicinity of the shaping. Preferably, this compression-improvement-means is an edge or an indentation or a discontinuity in the shape of the sidewall.

Preferably, the shaping is inserted into the sidewall-segment with one preferably two knurls, which are preferably located on each side of the sidewall-segment. These knurls are barred rotatably but stationary and the sidewall-segment is passed between the knurls. During this motion, the shaping is embossed into the sidewall-segment.

Another embodiment of the present invention is a sidewall-segment made for a container, which comprises a shaping, which is made while moving the sidewall-segment relative to a tool.

The disclosure made to the inventive processes also relates to the inventive sidewall-segment and vice versa.

Preferably the shaping comprises compression-improvement-means.

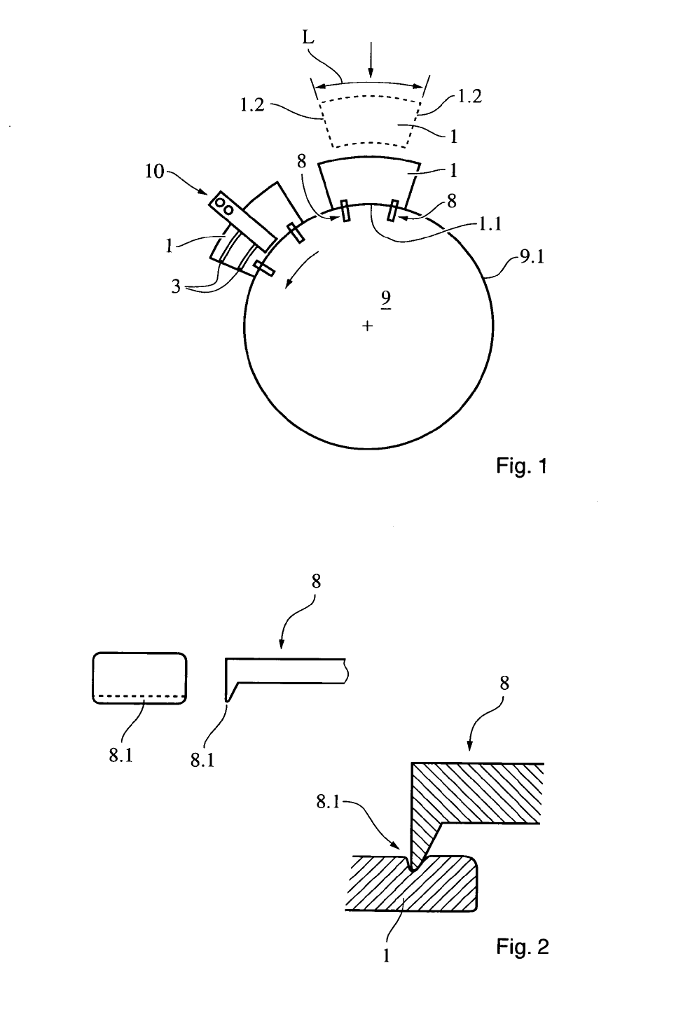

The inventions are now explained in further detail according to FIGS. 1-5c. These explanations do not limit the scope of protection of the present invention. The description relates to all embodiments of the present invention.

FIG. 1 shows the production of the sidewall-segment.

FIG. 2 shows gripping means, which hold the sidewall-segment.

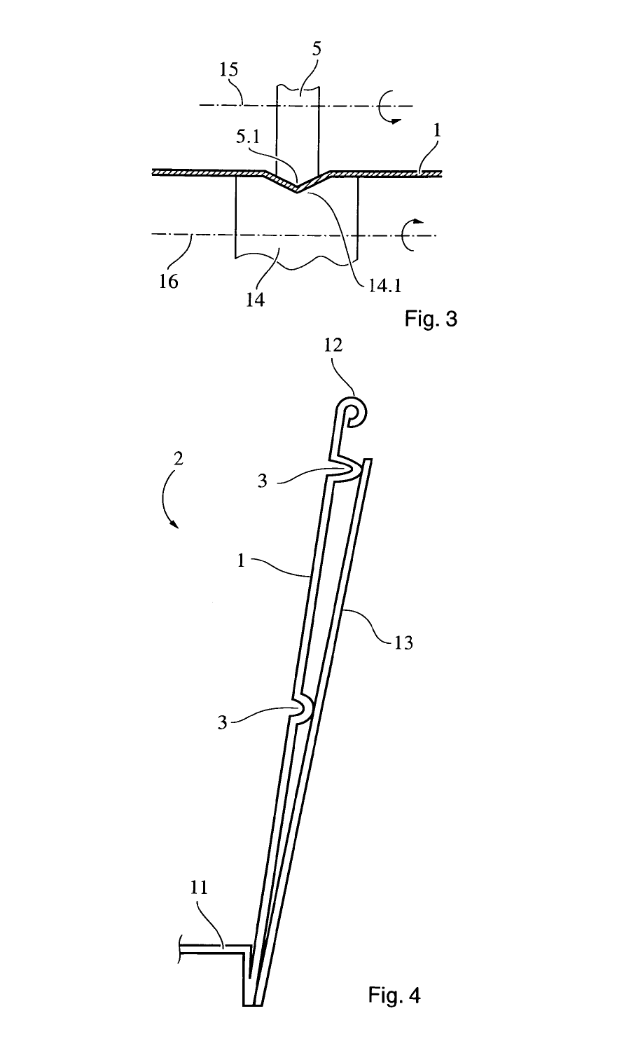

FIG. 3 shows knurls for the production of an embossment into the sidewall.

FIG. 4 shows a cup produced with a sidewall made according to the inventive process.

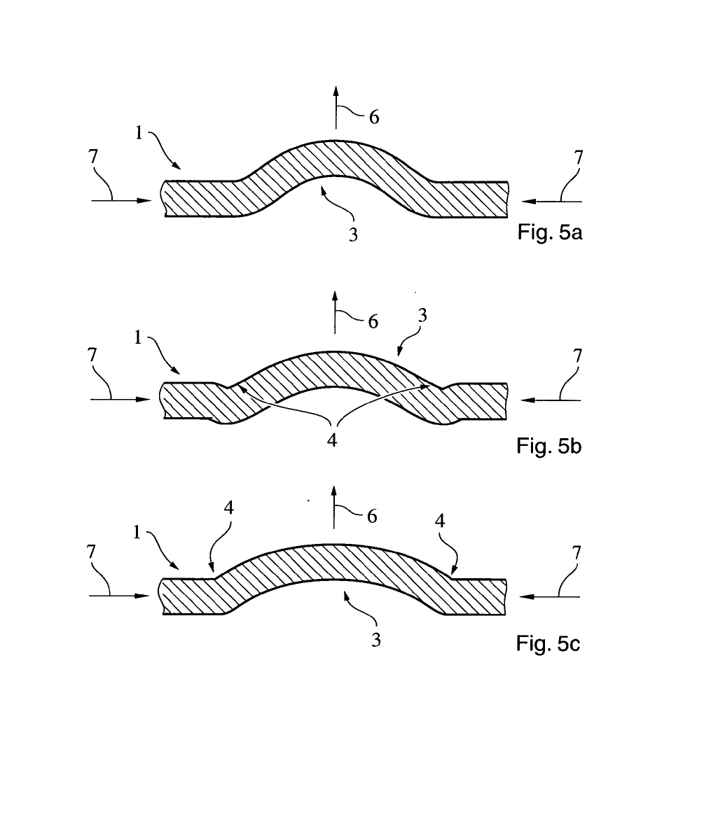

FIGS. 5a-5c show the compression-improvement-means.

FIG. 1 shows the inventive process. Preferably flat sidewall-segments 1 with such a footprint are provided, that, for example, a conical sidewall can be formed out of these sidewall-segments, for example by rolling the flat sidewall-segment. The flat sidewall-segments 1 are fed to a turret 9 for example a rotating disk, which comprises a multitude of gripping means 8 which are located around the circumference of the turret 9. These gripping means 8 fix the sidewall-segments 1 temporarily to the turret 9 and thus rotate the sidewall-segments 1 together with the turret 9. The inner diameter 1.1 of the sidewall segment preferably corresponds to the outer diameter 9.1 of the turret 9, whereas the inner diameter 1.1 preferably lies against the outer diameter 9.1 of the turret during their co-rotation. The turret 9 transports the sidewall-segment, here in a counter clockwise direction along a horizontal plane. During their movement, the flat sidewall-segments 1 each pass a shaping station 10, here an embossing station, which insert a shaping 3, here an embossment, along the entire length of the flat sidewall-segment. After the shaping 3 has been inserted into the sidewall-segment 1, each sidewall-segment is released from the turret 9 and handed over to a shaping station (not depicted) in which it is shaped, preferably rolled, into, for example, a conical sidewall 1. The ends 1.2 of the sidewall-segment are then connected, preferably glued, together, to maintain the sidewall in its shaped, preferably conical, state. Even though the shaping extent from one end to the other end, a perfectly leak proof sidewall can be produced with the inventive sidewall-segment. The shaping can be even compressed (compare FIGS. 4 and 5) without leakage-problems.

FIG. 2 shows the gripping means 8. These gripping means comprise a gripping finger 8.1 which has a sharp front edge, which presses in the flat sidewall-segment and thus fixes the sidewall-segment 1 to the turret 9 such, that the inner diameter 1.1 of the sidewall-segment lies against the outer diameter 9.1 of the turret. The gripper 8 is arranged such, that the fixation of the sidewall-segment takes place in a region which later on is attached to the base of the sidewall-segment and thus does not influence the appearance and/or the function of the sidewall. The person in the skilled in the art understands that preferably always two grippers 8 grip one sidewall-segment, even so one gripper might be sufficient. For large containers more than two grippers per sidewall-segments might be needed.

FIG. 3 shows two knurls 5, 14, whereas one knurl is located on one side of the flat sidewall-segment 1. Each knurl 5, 14 is mounted rotatably, whereas knurls 5 rotates around the axis, preferably the vertical axis, 15, while knurl 14 rotates around the axis, preferably the horizontal axis, 16. Preferably, the knurls are not powered but rotate, while the sidewall-segment passes through them. As can be seen from FIG. 3, the knurl 5 comprises a convexity 5.1, which extents around its entire circumference, while knurl 14 comprises a concavity 14.1 which also extents around the entire circumference of knurl 14. The convexity 5.1 and the concavity 14.1 are compatible in their shape and define the shape of the embossment. A gap is arranged between the two knurls 5, 14 through which the sidewall-segment passes.

FIG. 4 depicts an embodiment of a container 2, here a cardboard container, preferably a cup with a conically shaped first sidewall 1, which is made from a flat sidewall-segment. This container comprises a bottom 11, which is a separate part and attached, preferably glued, to the first sidewall 1. The container is, in the present case, entirely made from paper or cardboard. The first sidewall and the bottom 11 form a volume which can be filled with an item for example a beverage such as coffee, tea or a cold drink or a food such as soup or mash or borage. The sidewall 1 has an upper rim 12 located opposite of bottom 11. The sidewall comprises a first, lower circumferential shaping 3 and a second, higher, here also circumferential, shaping 3 which are both plastically embossed into the material of the first sidewall as already explained according to FIG. 1. At least one, here both shapings, are compressed in their height. Due to the compression, both shapings 3 are reduced in their height and increased in their radial extension. The compression is carried out elastically so that, as soon as the compression force is removed, the shapings 3 try to recover, at least partially, their original shape. Thus, each shaping 3 act as a spring. In order to secure the shapings 3 in their compresses state the container according to the present example comprises a second sidewall 13 which is sealed or glued to the first sidewall 1, here to the tips of the shapings 3 and possibly also at the bottom. While the second sidewall 13 is attached to the first sidewall 1, the shapings 3 are held in their compressed shape by an external force until the connection between the first sidewall 1 and the second sidewall 13 are sufficiently rigid.

The compression of the shaping is depicted according to FIG. 5a. After the shaping has been plastically inserted into the sidewall-segment 1, these shapings are compressed by an axial force 7 as can be seen in FIG. 5a.

In order to improve the compression of the shaping 3, preferably compression-improvement-means 4 are inserted into the sidewall 1. In the embodiment according to FIG. 5b, this compression-improvement-means 4 is an indentation which extents parallel to the shaping 3 and is preferably in the direct vicinity, more preferably at the rim of shaping 3. This compression-improvement-means 4 is also an embossment.

In the embodiment according to FIG. 5c, the compression-improvement-means 4 is an edge which is plastically formed or cut into the material of the sidewall.

### LIST OF REFERENCE SIGNS

1 sidewall-segment, sidewall
1.1 inner diameter of the sidewall segment
1.2 end of the sidewall-segment
2 container, cardboard container, cup
3 shaping
4 compression-improvement-means
5 knurl
5.1 convexity
6 folding direction
7 axial force
8 gripping means
8.1 gripper finger
9 turret
9.1 outer diameter of the turret
10 shaping station, embossing station
11 base
12 rim
13 second sidewall
14 knurl
14.1 concavity
15 axis of rotation
16 axis of rotation
L length of the sidewall segment

1. Process for the production of a sidewall-segment of a container with a shaping, wherein the shaping is inserted prior to forming the sidewall-segment into a sidewall of a container and extends around the entire circumference of the container.

2. Process preferably according to claim 1, wherein the sidewall-segment is transported, preferably rotated along a horizontal plane while the shaping is inserted.

3. Process preferably according to claim 1, wherein the shaping is pressed into the sidewall-segment by means of a die.

4. Process according to claim 1, wherein the shaping is made by plastic deformation.

5. Process according to claim 1, wherein the shaping is made by material removal.

6. Process according to claim 1, wherein a compression-improvement-means is provided to improve the compression of the shaping.

7. Process according to one of the preceding claims, claim 1, wherein the shaping is provided with at least one, preferably two, knurls, more preferably one on each side of the sidewall-segment.

8. Process according to claim 6, wherein the compression-improvement-means comprises an indentation formed at a rim of the shaping and extending parallel to the shaping.

9. Process according to claim 6, wherein the compression-improvement-means is an embossment plastically formed or cut into the sidewall-segment.

10. Process for the production of a sidewall-segment of a container with a shaping, wherein the shaping is formed prior to forming the sidewall-segment into a sidewall of a container and extends around the entire circumference of the container, wherein the shaping is compressed after the shaping has been formed.
